(19) United States
(12) Patent Application Publication
(10) Pub. No.: US 2015/0162740 A1
(43) Pub. Date: Jun. 11, 2015

(54) Safe Service Mode

(71) Applicant: DGI Creations, LLC, Raleigh, NC (US)

(72) Inventor: Charles T. Barnes, Houston, TX (US)

(21) Appl. No.: 14/561,629

(22) Filed: Dec. 5, 2014

Related U.S. Application Data
(60) Provisional application No. 61/912,488, filed on Dec. 5, 2013.

(51) Int. Cl. H02H 3/08

(52) U.S. Cl. CPC H02H 3/083

(57) ABSTRACT

Control of network protectors through the monitoring of local conditions by a network protector relay which may react to local conditions to open the network protector relay. Including various methods for detecting an arc flash on the load side of a network protector and interceding to stop current flow to the arc flash.

This application incorporates by reference and claims the benefit of U.S. Provisional Patent Application No. 61/912,488 filed Dec. 5, 2013 with title Safe Service Mode.

### BACKGROUND

### Field of the Invention

This disclosure relates generally to the control of network protectors through the monitoring of local conditions by a network protector relay which may react to local conditions to open the network protector relay.

The control of the network protector by an associated relay may be combined with remote monitoring of the conditions of electric power network components, particularly transformers. Parameters and status flags for a transformer may be communicated by any one of a number of methods such as power line carrier (PLC), which introduces a high frequency analog signal onto a power cable used to convey power in a portion of an electric distribution network. Information about the various transformers in a given electrical distribution network may be aggregated and monitored at a central location.

Electrical Distribution Network.

FIG. 1 introduces the environment relevant to the present invention. A portion of an electrical distribution network is shown as network 100. Network 100 has feeder bus 104, feeder bus 108, and feeder bus 112. A representative voltage for operation of these feeder buses may be 13Kv but other systems may operate at 27Kv, 34Kv or some other voltage. The power on these three buses is provided to a set of local distribution networks 116 (local networks”) to serve loads 120, 124, and 128. The voltage on these local distribution networks is apt to be 120 volts, but it could be 277 volts, 341 volts or some other voltage. In some cases these loads represent a building or even a portion of a very large building. Depending on the amount of load, the local distribution network may be coupled to one, two, or three feeder buses (104, 108, and 112). Even when the load can consistently be serviced by just one feeder bus, a desire for reliability leads to providing a redundant path for providing service in case of equipment failure, scheduled maintenance, load balancing, or other needs.

The local networks 116 are coupled to the feeder buses 104, 108, and 112 through transformers 150 and related equipment. The illustrated network shown in FIG. 1 has three separate local networks 116 which serve loads 120, 124, and 128. These three separate local networks 116 can be provided at any given time with power flowing through zero, one, or more than one transformer 150. The transformers convert the relatively higher voltage on the primary side 154 of the transformers 150 to the low voltage on the secondary side 158 of the transformers 150.

The transformers 150 have transformer breakers 162 on the primary side to isolate the transformers 150 from the feeder buses (104, 108, and 112). The transformers 150 have network protectors 166 on the secondary side 158 of the transformers 150 to isolate the transformers 150 from the local networks 116 as needed to protect the transformers from current flowing from the distribution networks (secondary side 158) to the primary side 154 of the transformers. To have current flowing from the secondary side 158 to the primary side 154 of a transformer is undesirable. This undesirable current flow is known as “back feed” or “reverse power flow”.

A network protector relay 168 may be used to monitor a set of local parameters and make informed decisions on whether to open a network protector 166 to stop the flow of current through the network protector 166 or to close the network protector 166 to allow for the flow of current. While normally, each network protector 166 would have a network protector relay 168; FIG. 1 has just one example of a network protector relay to avoid undue clutter. In addition to monitoring for backflow current, the network protector relay 168 may be used to monitor for a fault allowing current to flow in an undesired direction as described in detail below.

Additionally, some networks include sets of fuse links 170 between the network protectors 166 and the local networks 116. Some networks include sets of primary fuse links 174 between the transformer breakers 162 and the feeder buses 104, 108, and 112.

The feeder buses 104, 108, and 112 can be isolated by a set of substation breakers 204 from the transmission network 208 which is ultimately connected to a set of power sources represented here by turbine 212.

Network Protectors and Back Feed.

Electric utilities use network protectors 166 and their associated network protector relays 168 to automatically connect and disconnect the network transformer 150 associated with a particular network protector 166 from the local network 116. Typically, the network protector is set to close when the voltage differential and phase angle are such that the transformer 150 will supply power to the local network 116. In other words, the net current flow across the transformer 150 will be from the primary side 154 to the secondary side 158 and towards the loads (such as 120, 124, and 128). Network protectors 166 are supposed to open up (trip) to prevent back feed across a transformer (from secondary side 158 to the primary side 154). As mentioned below, the network protector 166 may have a delay that keeps the network protector 166 from opening during a transient back feed. Typically, the network protector 166 is contained in a submersible enclosure which is bolted to the network transformer and placed with the transformer 150 in an underground vault.

Remote Monitoring of Electrical Distribution Network.

FIG. 1 shows a small portion of the network which may have more feeder buses and many more local networks 116 providing power to many more loads. These loads may be distributed around a portion of a city. The various transformers 150 may be in vaults near the various loads. Thus it is convenient to aggregate information about many different transformers at a monitoring station 260. The information about the transformers may be communicated using any known communication media including fiber optic fiber, wired communication including communication routed for at least a portion of the trip over telephone or data communication lines, wireless communication or power line carrier. Power line carrier is a frequent choice as it can be convenient to inject analog signals onto the power lines so that the analog signals can be picked off by pick-up coils 230 at the substation and fed to a receiver 220. While FIG. 1 shows only one transmitter 216, it is understood that a series of transmitters, one for each monitored transformer 150 would be present in an actual network, and the transmitters 216 would communicate through various communication routes possibly including power line carrier to various pick-up coils 230 connected to one or more receivers and the various receivers 220 for a given portion of the distribution network would be in data communication with a monitoring station 260. The transmitter 216 receives data for transmission from the network protector relay 168.

The precise way that the analog signals are removed from the power line is not relevant to the scope of the present disclosure, but one typical means for acquiring the analog carrier signal is through a pick-up coil 230 such as a Rogowski air coil as is known in the art. These analog signals are often in the frequency range of 40 KHz to 70 KHz which is much higher than the frequency of the power being distributed over the network. (For example one common frequency for power grids is 60 Hertz although other frequencies are used throughout the world and can be used in connection with the present disclosure).

One suitable location for injecting the analog signal containing information about the operation of a transformer and related equipment is on the secondary side 158 of the transformer between the transformer 150 and the network protector 166. Transmitter 216 is shown in FIG. 1 to illustrate this location but it is understood that each transformer 150 would most likely have its own transmitter. Placement of transmitter 216 in this location allows for the injection of the analog signal onto the relatively low voltage, secondary side 158 of the transformer 150. Traversing the transformer 150 from secondary side 158 to primary side 154 provides only a slight attenuation of the high frequency carrier signal used in power line carrier communication. One data communication path for the power line carrier signal is from transmitter 216 on the secondary side 158 of the transformer 150 to the primary side 154, then through the transformer breaker 162, primary fuse 174, feeder bus 104, pick-up coil 230 and ultimately to receiver 220. This data path is not impacted by the opening of the network protector 166 or the relevant fuse link 170. The data collected by one or more receivers 220, 222, and 224 may be fed to a monitoring station 260 which allows an operator to see the current state of various components and look at trends and other representations of data over time in order to monitor, manage, and troubleshoot the electrical distribution network.

Commonly assigned U.S. Pat. No. 7,366,773 teaches Alternative Communication Paths for Data Sent Over Power Line Carrier to make it possible for the data to reach the receiver even if one of the components along a primary communication path is open and not conducting data.

The monitoring station 260 may be used to send communications to one or more transmitters 216 which may pass the communication to the network protector relay 168 to alter the functioning of the network protector relay 168 or ask for a change in the open/close status of the associated network protector 166.

General Description of Arc Flashes.

Arc flashes include phase to phase faults were current flows from one phase to one or both of the other phases. A second type of arc flash is phase to ground where current flows to ground. An arc flash is distinguished from another type of fault in that an arc flash has an electrical arc that is a path of current through air. While the physics of arcs and plasma are beyond the scope of this discussion, it is noteworthy that the amount of current that passes through an arc is not limited by the arc and will rise to the maximum current available.

Arc flashes can be extremely destructive to equipment as the current flow leads to intense temperatures. This can melt components and lead to fires. An arc flash leads to two distinct destructive components, an arc flash and an arc blast. The arc flash is the light and heat produced from an electric arc with enough energy to cause substantial damage or harm. The temperatures associated with an arc flash can vaporize metal.

Arc flashes can arise from a number of different sources. Sometimes the cause is as simple as insulation breaking down. Other times dirt or debris from maintenance work may form a bridge which leads to an arc flash. The bridge allows the current flow to start but then the flow is maintained via an arc.

Arc flashes can damage or destroy components, but a bigger concern is that the destructive energy in an arc flash is dangerous to any personnel near the arc flash.

Symmetrical Components

As noted in Wikipedia for the entry of Symmetrical Components—In electrical engineering, the method of symmetrical components is used to simplify analysis of unbalanced three phase power systems under both normal and abnormal conditions. In 1918 Charles Legeyt Fortescue presented a paper which demonstrated that any set of N unbalanced phasors (that is, any such polyphase signal) could be expressed as the sum of N symmetrical sets of balanced phasors, for values of N that are prime. Only a single frequency component is represented by the phasors.

In a three-phase system, one set of phasors has the same phase sequence as the system under study (positive sequence; say ABC), the second set has the reverse phase sequence (negative sequence; ACB), and in the third set the phasors A, B and C are in phase with each other (zero sequence). Essentially, this method converts three unbalanced phases into three independent sources, which makes asymmetric fault analysis more tractable. By expanding a one-line diagram to show the positive sequence, negative sequence and zero sequence impedances of generators, transformers and other devices including overhead lines and cables, analysis of such unbalanced conditions as a single line to ground short-circuit fault is greatly simplified. The technique can also be extended to higher order phase systems.

Physically, in a three phase winding a positive sequence set of currents produces a normal rotating field, a negative sequence set produces a field with the opposite rotation, and the zero sequence set produces a field that oscillates but does not rotate between phase windings. Since these effects can be detected physically with sequence filters, the mathematical tool became the basis for the design of protective relays, which used negative-sequence voltages and currents as a reliable indicator of fault conditions. Such relays may be used to trip circuit breakers or take other steps to protect electrical systems.

As can be discerned through a review of the literature, the use of positive sequence components and negative sequence components to analyze three-phase power is known to those of skill in the art and needs not be discussed in great detail here.

### SUMMARY

Aspects of the teachings contained within this disclosure are addressed in the claims submitted with this application upon filing. Rather than adding redundant restatements of the contents of the claims, these claims should be considered incorporated by reference into this summary.

This summary is meant to provide an introduction to the concepts that are disclosed within the specification without being an exhaustive list of the many teachings and variations upon those teachings that are provided in the extended discussion within this disclosure. Thus, the contents of this summary should not be used to limit the scope of the claims that follow.

Other systems, methods, features, and advantages of the disclosed teachings will be or will become apparent to one with skill in the art upon examination of the following figures and detailed description. It is intended that all such additional systems, methods, features and advantages be included within the scope of and be protected by the accompanying claims.

### BRIEF DESCRIPTION OF THE FIGURES

The disclosure can be better understood with reference to the following figures. The components in the figures are not necessarily to scale, emphasis instead being placed upon illustrating the principles of the disclosure. Moreover, in the figures, like reference numerals designate corresponding parts throughout the different views.

FIG. 1 introduces the relevant components in an electrical distribution network and the devices used to convey information about components to a remote monitoring station.

FIG. 2 provides a high-level overview of one implementation of the safe service mode operation.

FIG. 3 shows an overview of the test set-up used for the test results discussed in this disclosure.

### DETAILED DESCRIPTION

As the network protector 166 is used to isolate a transformer 150 from a spot network 116 in order to protect equipment and people, prior art systems and methods would be improved if the network protector could be operated to open and thus stop the flow of current when an arc flash is detected. Given the large current levels that may be flowing through the transformer 150, prompt cessation of current flow to an arc flash may prevent significant damage to equipment. However, there is a careful balance between the goal to minimize the damage to equipment and the paramount concern to not inconvenience customers with interruptions in the flow of power caused by false positive test results (opening a network protector 166 to stop a suspected arc flash that is only a transient rather than a true arc flash). Thus, as long as utility personnel are not in the vault, a utility may prefer to assume the small risk of an arc flash not being caught quickly in favor of higher reliability for service.

The equation changes when one or more utility workers are going to enter a vault to work with one or more pieces of equipment in the vault. In some instances, a worker can work with an energized transformer 150 if proper safety precautions are strictly adhered to. In other instances the worker may be working with equipment that is isolated from power but this equipment is in a vault that also contains other equipment that is still energized or may become energized. Given the severe risks to personnel from an arc flash, a utility may opt to place all network protector relays 168 in a given vault into a special mode that is biased to quickly detect and respond to a perceived arc flash, even at the risk of responding to a false positive. After the personnel are all safely out of the vault, the special safe mode of operation can be switched to one that is less prone to open a network protector 166 in response to a false positive indication of an arc flash.

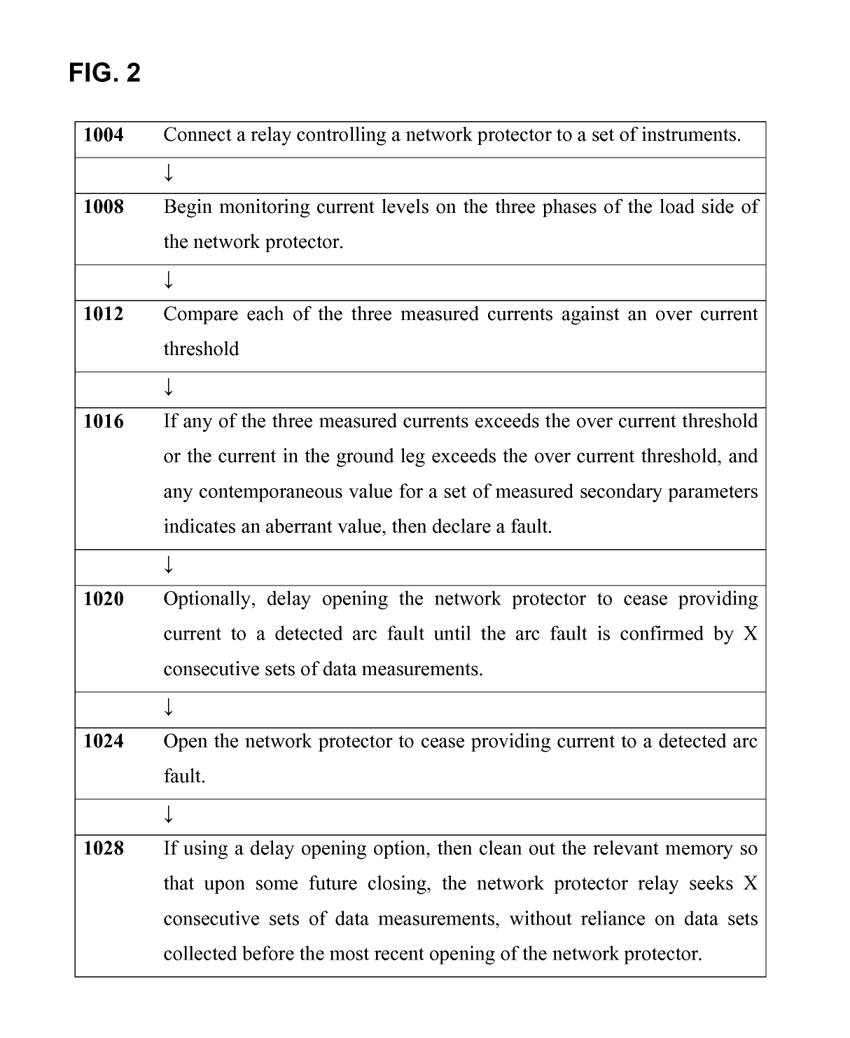

FIG. 2 provides a high-level overview of one implementation of the safe service mode operation.

Step 1004—Connect a relay controlling network protector to a set of instruments. Those of skill in the art will recognize that the network protector is itself connected to a set of instruments. In many instances, step 1004 is achieved by connecting the relay to the network protector.

Step 1008—Begin monitoring current levels on the three phases of the load side of the network protector.

Step 1012—Compare each of the three measured currents against an over current threshold.

Step 1016—If any of the three measured currents exceeds the over current threshold or the current in the ground leg exceeds the over current threshold, and any contemporaneous value for a set of measured secondary parameters indicates an aberrant value, then declare a fault.

Step 1020—Optionally, delay opening the network protector to cease providing current to a detected arc fault until the arc fault is confirmed by X consecutive sets of data measurements.

Step 1024—Open the network protector to cease providing current to a detected arc fault.

Step 1028—If using a delay opening option, then clean out the relevant memory so that upon some future closing, the network protector relay seeks X consecutive sets of data measurements, without reliance on data sets collected before the most recent opening of the network protector.

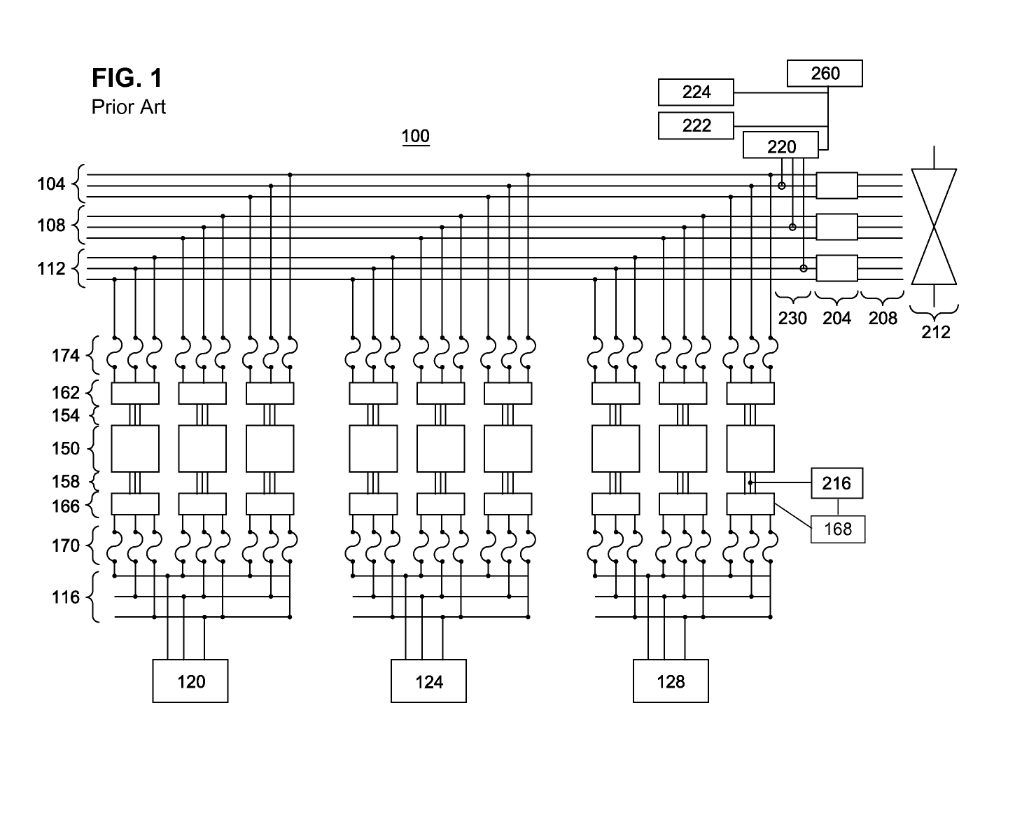

As network protector relays 168 typically monitor the voltages and current flows on each of the three phases on the load side of the network protector 166, a disclosure of how to provide such measurements to the network protector relay 168 would not be required by those of skill in the art. Note, these details are not visible in FIG. 1 but many of these connections to monitor network parameters are implied in FIG. 1 as otherwise the network protector relay 168 would not serve much of a function.

An analog to digital converter may be used to convert samples of analog measurements of voltage or current into digital values. The sample rate may be relatively large such as 128 samples per one cycle of sixty Hertz alternating current. One skilled in the art could see that the number of samples is not critical to the disclosed methods and sampling rates may be significantly different than 128 samples per cycle.

The digitized current levels representing current flows on the three phases on the load side of the network protector are compared against a setting that is used to detect over current. The over current threshold may be 5500 amps for one system. The over current set point may be set to something different based on the bolted fault current of the system. The over current setting may be influenced a number of other factors.

The phasor sum of the three currents may be also compared against the over current set point. This phasor sum is particularly useful in detecting flow of current to ground. As noted in connection with Step 1016, this flow of current to ground is the fourth value that is compared with the over current threshold. During a three phase flash, the three currents are now linked and thus have the same phase. The phasor sum will thus be three times the magnitude of a single phase. This makes the phasor sum particularly useful in detecting a three phase flash.

Note, while calculating current to ground from other readings may be convenient as a direct measurement may not be readily available, a direct measurement of current flow to ground could be used in addition to or instead of the calculated value. Likewise, many parameters may be calculated from several measured parameters. Thus, there may be options to calculate rather than measure or measure rather than calculate. Variations in how a parameter is measured, calculated, or estimated do not impact the scope of the claims that follow.

Having a secondary indication confirm that an over current is not a mere transient condition allows the system to quickly act, perhaps with a zero cycle delay, while minimizing the risk of false trips based on mere transients.

The existence of a true fault that merits opening the network protector 166 is confirmed by the existence of an aberrant value of at least one of a set of measured secondary parameters. Ideally, some of the set of measured secondary parameters should be useful in confirming a phase-to-phase fault or a three-phase fault, and some of the set of measured secondary parameters should be useful in confirming a phase-to-ground fault. Some of the set of measured secondary parameters may be useful in confirming two or more types of faults.

Voltage Imbalance.

One secondary parameter may be voltage imbalance. Under normal conditions (without a fault), the negative sequence voltage phasor is around zero volts. Imperfections in measuring equipment and imperfections in the system may lead to a negative sequence voltage that is not exactly zero, thus a voltage imbalance threshold may be chosen to distinguish normal situations and an indication of a fault.

Low Voltage.

One secondary parameter may be low voltage. Under normal conditions (without a fault), the positive sequence value of the network voltages should be around 125 volts at zero degrees. A typical low voltage setting for a system with a 125 volt norm may be 100 volts. A voltage of less than 100 volts combined with an over current in excess of the over current setting is an indication of a fault.

Current Imbalance.

One secondary parameter may be current imbalance. The current imbalance parameter looks at the ratio of the negative sequence of the three currents compared to the positive sequence of the three currents. A current imbalance ratio of 0.8 combined with an overcurrent in excess of the over current setting is an indication of a fault.

Delay.

Optionally, a delay may be imposed so that the network protector may be opened after a set of X consecutive cycles where there was both a detected over current and at least one measured secondary parameter exhibiting an aberrant value.

While many systems may be set up to initiate opening of the network protector after one cycle (approximately one sixtieth of a second for a 60 Hertz system), other systems may want to have two or more consecutive cycles indicating a fault before opening the network protector. By “consecutive cycles” it is meant that the counter of cycles exhibiting existence of a fault would be reset whenever a cycle does not produce an indication of a fault.

In one implementation, the process seeks consecutive cycles of over current plus at least one aberrant value for at least one secondary parameter although the method does not require the same secondary parameter to be out of range for the consecutive cycles. An alternative would be to require both an over current and the same secondary parameter be out of range for the required delay duration.

One of ordinary skill in the art will recognize that delay settings could be provided in terms of time duration rather than cycles.

### Examples

Using a network protector provided with 480 volts, a series of fault conditions were created in order to test the operation of a relay operated in safe mode. The faults included, phase to phase, three-phase, and phase to ground faults.

The fault levels for the test will be based on the high and low levels of fault current for a 480V arcing fault expected to be seen by a 2500 Amp NETWORK PROTECTOR. The low fault current level for testing will be 7000 Amps and the high fault current level will be 25000 Amps.

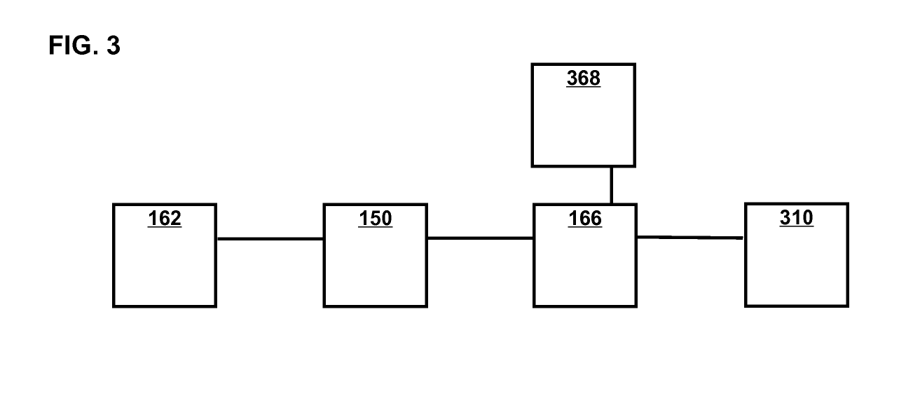

A network protector master relay 368 (Model DG-6001) modified to have safe service mode was installed in a 277/480 volt 2500 Amp three-phase Westinghouse style network protector typically used with a 1500 KVA network transformer. (277 volts phase to ground and 480 volts phase to phase.) As shown in FIG. 3, the pattern shown in FIG. 1 of breaker 162, transformer 150, and network protector 166 is repeated. For purposes of this test, a test component 310 which may be an empty housing with jumpers installed to create an arc flash is connected to the network protector 166. This setup allows testing of the efficacy of the modified network protector master relay 368 in reacting to an arc flash.

Those of skill in the art will know that many network protectors use conventions found in Westinghouse equipment and many other network protectors use conventions found in General Electric equipment. While testing was done with one set of equipment, the teachings of the present disclosure could be used with GE style equipment in addition to Westinghouse style equipment.

On its transformer side, the network protector 166 was connected to a high power source. On its load side, the network protector 166 was connected to the test component 310 which was an empty network protector housing where a fault would be initiated by installing jumpers between bus bars of different phases or a bus bar and ground. The jumpers were small gauge copper wires. These copper wires were vaporized as soon as energized by the large current flows, but the current continued to flow through the air once the path had been established so as to establish an arc flash.

The safe service mode in was enabled in the network protector relay 368 controlling the network protector 166 and all relevant instruments (not shown here) were connected. The settings used for testing were as follows:

Over Current: 500 Amps

Voltage Imbalance: 3.0 Volts

Low Voltage: 100 Volts

Current Imbalance: 0.5

Delay: 0 Cycles

To initiate the test, a fault is added to the test component 310 before the network protector 166 is closed. The fault may be a copper wire running between two or more copper bus bars in the empty network protector (test component 310). Alternatively, the fault may be a copper wire between one or more bus bars and ground.

After the fault has been added to the empty network protector (test component 310), the breaker 162 shown in FIG. 3 is closed to provide power to the network protector 166 which starts in its open position. As there is a connection to provide power to the network protector 166 from one of the phases between the transformer 150 and the network protector 166 (As discussed in co-pending and commonly owned U.S. patent application Ser. No. 14/193,754 for Alternative Power Source for Network Protector Relay with docket number DC12002USU—incorporated by reference herein) closing the breaker 162 also serves to provide power to the network protector relay 368. As the network protector relay 368 is set to close the network protector 166 when the network protector relay 368 senses that the load side of the network protector 166 is at zero volts (a dead network), the network protector relay 168 causes the network protector 166 to close.

As soon as the network protector 166 closes, power will flow through the network protector 166 to the empty network protector housing (test component 310) to feed the fault that has been set up at that location. Finally, the network protector relay 368 which is monitoring the power conditions in the vicinity of the network protector 166 will detect the fault and initiate a trip to open the network protector 166 and end the test.

One set of test were conducted with 25000 amp fault currents. Results of the tests with a phase to phase fault and a three phase fault tests were quite similar. For a test of a three phase fault, the following results were noted.

The time to energize and close in the network protector 2.892 seconds as the network protector relay needed to boot after switching from de-energized to energized and then detect the dead network before causing the network protector to close. The fault would not be active until the network protector was closed to provide current to the fault.

The time to detect the fault and call for the network protector to trip open: was 0.024 seconds.

The time for the network protector to mechanically trip open was 0.042 seconds.

The total time for the relay to detect the fault and for the opening network protector to interrupt the fault was 0.066 seconds or 4 cycles. Note that the majority of the time to interrupt the fault was consumed by the mechanical movement of the network protector. The actual time to detect the fault was relatively quick.

| | 25K Three-Phase Fault | | | | |
|---|---|---|---|---|---|
| | | | Captured Value | | Indication of |
| Parameter | Set point | | during Fault | | fault? |
| Over Current: | 500 | Amps | 20164 | Amps | Yes |
| Voltage Imbalance: | 3.0 | Volts | 4 | Volts | Yes |
| Low Voltage: | 100 | Volts | 82 | Volts | Yes |

| | | | |
|---|---|---|---|
| Current Imbalance Ratio: | 0.5 | 0.08 | No |

The results of the two-phase fault tests were quite similar to that seen during the three-phase fault tests. The time to detect and interrupt the fault and Over Current and Low Voltage inputs were almost identical. The Voltage and Current Imbalances inputs were around three times higher during the two-phase fault versus the three-phase fault.

| | 25K Two-Phase Fault | | | | |
|---|---|---|---|---|---|
| | | | Captured Value | | Indication of |
| Parameter | Set point | | during Fault | | fault? |
| Over Current: | 500 | Amps | 19463 | Amps | Yes |
| Voltage Imbalance: | 3.0 | Volts | 18.0 | V | Yes |
| Low Voltage: | 100 | Volts | 81 | V | Yes |

| | | |
|---|---|---|
| Current Imbalance Ratio: | 0.5 | No |

25000 Amp Phase to Ground Fault.

The results of the one phase to ground fault test showed a successful fault detection and interruption. The time to do this was longer than the three phase fault tests or the two-phase fault tests as the Safe Service Mode delay setting was set at 3 cycles. The Over Current input was around ⅓ of that seen in the other tests with a much larger Current Imbalance. Due to test system issues, the Low Voltage and Voltage Imbalance inputs were not obtained.

| | 25K Phase-GND Fault | | | |
|---|---|---|---|---|
| | | | Captured Value | Indication of |
| Parameter | Set point | | during Fault | fault? |
| Over Current: | 500 | Amps | 8395 Amps | Yes |
| Voltage Imbalance: | 3.0 | Volts | Did Not Capture | Unknown |
| Low Voltage: | 100 | Volts | Did Not Capture | Unknown |

| | | | |
|---|---|---|---|
| Current Imbalance Ratio: | 0.5 | 1.00 | Yes |

7000 Amp Fault Testing

Five tests were performed with a fault current of 7000 Amps: two tests with a three-phase fault, two tests with a two-phase fault, and one test with a phase to ground fault.

Three Phase Fault Testing.

Results of the two- and three-phase fault tests were quite similar. Test results indicate that the timing of a three-phase fault.

The time to energize and close in the network protector 2.862 seconds as the network protector relay needed to boot after switching from de-energized to energized and then detect the dead network before causing the network protector to close. The fault would not be active until the network protector was closed to provide current to the fault.

The time to detect the fault and call for the network protector to trip open: was 0.035 seconds.

The time for the network protector to mechanically trip open was 0.012 seconds. The total time/cycles it took for the relay to detect the fault and open the network protector sufficiently to interrupt the fault was 0.047 seconds or approximately three cycles at 60 Hertz. One of skill in the art will appreciate that a network protector will need to expend more energy to break current flows of 25,000 amps than to break current flows of 7000 amps. Thus it is not surprising that the action of the network protector took less time for the 7000 amp trials.

| | 7K Three-Phase Fault | | | | |
|---|---|---|---|---|---|
| | | | Captured Value | | Indication of |
| Parameter | Set point | | during Fault | | fault? |
| Over Current: | 500 | Amps | 6896 | Amps | Yes |
| Voltage Imbalance: | 3.0 | Volts | 3 | Volts | Yes |
| Low Voltage: | 100 | Volts | 9 | Volts | Yes |

| | | | |
|---|---|---|---|
| Current Imbalance Ratio: | 0.5 | 0.14 | No |

7000 Amp Two-Phase Fault.

The results of the two-phase fault tests were quite similar to that seen during the three-phase fault tests. The time to detect and interrupt the fault and Over Current input were almost identical to that seen during the three-phase fault tests. The Low Voltage, Voltage Imbalance, and Current Imbalance inputs (shown below) were significantly higher during the two-phase fault tests the three-phase fault tests.

| | 7K Two-Phase Fault | | | | |
|---|---|---|---|---|---|
| | | | Captured Value | | Indication of |
| Parameter | Set point | | during Fault | | fault? |
| Over Current: | 500 | Amps | 6508 | Amps | Yes |
| Voltage Imbalance: | 3.0 | Volts | 62 | Volts | Yes |
| Low Voltage: | 100 | Volts | 64 | Volts | Yes |

| | | | |
|---|---|---|---|
| Current Imbalance Ratio: | 0.5 | 1.00 | Yes |

7000 Amp Phase to Ground Fault.

The results of the one phase to ground fault test showed similar fault detection and interruption times as the other 7KA fault current tests. The Safe Service Mode inputs were very close to that seen during the two-phase fault tests.

| | 7K Phase-GND Fault | | | | |
|---|---|---|---|---|---|
| | | | Captured Value | | Indication of |
| Parameter | Set point | | during Fault | | fault? |
| Over Current: | 500 | Amps | 6135 | Amps | Yes |
| Voltage Imbalance: | 3.0 | Volts | 35 | Volts | Yes |
| Low Voltage: | 100 | Volts | 96 | Volts | Yes |

| | | | |
|---|---|---|---|
| Current Imbalance Ratio: | 0.5 | 1.00 | Yes |

Summary of Test Results.

| | Fault Detection | Fault Detection |
|---|---|---|
| | and Interrupt | and Interrupt |
| Amperage | in seconds | in 60 Hz cycles |
| 25000 | 0.066 | 4 |
| 7000 | 0.047 | 3 |

Fault Detection and Interrupt Times.

The fault detection and interrupt times include:
detection of the fault by the Safe Service Mode feature,
trip contact closure in the DGI Network Protector Relay, and
mechanical operation of the network protector to trip open.

Sample Set of Recommended Safe Service Mode Settings

Based on the data collected during the tests at both 25000 and 7000 Amp Fault Current levels, one set of recommended settings may be:
Over Current: 5500 Amps
Voltage Imbalance: 10 Volts
Low Voltage: 95 Volts
Current Imbalance: 0.8
Delay: 0 Cycles.

The recommended Over Current setting is based on the current values seen during the 7000 Amp Fault Current level tests which were all greater than 6100 Amps. The current values observed during the 25000 Amp tests were all much greater than that seen at the 7000 Amp level.

All the three- and two-phase faults at both test current fault levels were detected by the Low Voltage and/or Voltage Imbalance settings with the Over Current setting exceeded.

In contrast, the phase-to-ground faults at each current fault level were detected by the Current Imbalance and/or Voltage Imbalance settings with the Over Current setting exceeded.

Alternatives and Variations

Use Outside of Network Protector Relay.

While the description set forth above, presumes that a network protector relay that is used to open and close the network protector based on measured parameters and external inputs is enhanced to add the safe service mode, the concepts set forth in this disclosure could be implemented in a free-standing device that acts to detect an arc flash and then provide a command to the network protector relay to open the network protector. This variation allows new functionality to be added to legacy network protector relays.

Remote Interaction with Network Protector Relay.

Optionally, the operation of the network protector relay 168 may be altered using commands generated at a remote location. The network protector relay 168 can be put into the safe service mode remotely through a communication system using a wired or wireless communication protocol including power line carrier, telephone, fiber optics, optically coupled serial ports, and wired computer links.

The operator at a remote location can be alerted to the status of the network protector relay including whether the relay is operation is safe mode. For example, the receiver software on the monitoring station 260 may be configured to display a flag/status that indicates the network protector relay is currently in safe service mode so if a particular network protector relay 168 is accidentally left in the safe service mode after the service is complete and the workers have left the vault, there will be a remote notification so operators can remotely request that the network protector relay 168 switch out of safe mode. As noted above, switching out of safe service mode may decrease the risk of false positive reactions to mere transients. For a system that does not allow this sort of incoming command to be sent over a communication network, the operator could or send someone out to change the network protector relay 168 state back to a normal operating mode.

Variation on Use of Safe Service.

The introduction to the use of safe service mode assumed that safe service mode was engaged before workers entered the vault and terminated after the workers left the vault so that the heightened sensitivity to potential arc flash situations is turned off to reduce the risk of false positive reactions to mere transients. However, other possible uses of safe service mode exist.

The safe service mode could be adopted either by the manufacturer or by a utility as a default mode of operation that is used all the time. Thus, a small increase in risk of a false positive reaction to a mere transient is deemed acceptable (especially if the safe service mode leads to very few false positive incidents).

An intermediate position would be to use safe service mode with zero or short delays when workers are in the vault (hair trigger mode) but require a longer stable indication of a problem when workers are not around. Perhaps an ongoing indication of a fault from both an over current and a secondary parameter for five consecutive power cycles.

Use of Other Secondary Parameters.

While a useful set of three secondary parameters has been discussed above, this list is not intended to be exhaustive or to be absolute requirements as other secondary parameters may be viable substitutes for one or more of the secondary parameters discussed above. Additional secondary parameters useful in confirming the presence of an arc flash include:
Looking for Electro-Magnetic Frequency emissions indicative of an arc. (See for example U.S. Pat. No. 7,577,535 for System and Method for Locating and Analyzing Arcing Phenomena).
Looking for Optical Indications of an arc as an arc is very bright. This may be complicated by the presence of utility workers with bright lights working in what is normally a dark vault. There is also a need to orient the optical equipment towards the likely location of an arc flash.
Any other measurement currently known to those of skill in the art as a reliable marker for an arc flash.

Monitoring of Secondary Parameters.

A designer may choose to implement the teachings of the present disclosure by only processing measurements and making calculations and comparisons necessary for evaluating the secondary parameters when an over current has been detected.

Duration Granularity Not Tied to Cycles.

While the system described above uses on sixty Hertz cycle (or the local power frequency) as the minimal increment of time, this is not a requirement to practice the invention. Given the rapid conversions and processing of date via the analog to digital converters, appropriate equipment could be set to detect an arc flash in less than the time associated with one 60 Hertz cycle (approximately 0.0167 seconds). Likewise, the delay duration used to require sustained indication of an arc flash could be a time duration that is not an integral multiple of cycles.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

1. A method of detecting an arc flash on a load side of a network protector, the method comprising:
monitoring current flow on all three phases on the load side of the network protector and a ground current until a monitored current exceeds a high current threshold,
then
declaring an overcurrent status,
checking a set of secondary parameters to see if an aberrant value is detected to confirm that the overcurrent status appears to indicate an arc flash;
after preset delay duration of both an overcurrent status and an aberrant value, trip the network protector to stop a flow of current to the arc flash.

2. The method of claim 1 where the preset delay duration is zero so that a process to trip network protector is started upon detection of both an overcurrent status and an aberrant value for at least one secondary parameter.

3. The method of claim 1 wherein the preset delay duration is in excess of one alternating current cycle of a waveform for a frequency of power being delivered through the network protector.

4. The method of claim 3 wherein the frequency of power delivered through the network protector is 60 Hz and the delay is in excess of one sixtieth of a second.

5. The method of claim 1 wherein the set of secondary parameters includes voltage imbalance which looks for a negative sequence voltage phasor level amongst the three phases on the load side of the network protector.

6. The method of claim 1 wherein the set of secondary parameters monitored includes at least one secondary parameter that may be used to confirm a phase to ground flash.

7. The method of claim 1 wherein the set of secondary parameters monitored includes at least one secondary parameter that may be used to detect a phase to phase flash.

8. The method of claim 1 wherein the set of secondary parameters monitored includes at least one secondary parameter that may be used to detect a three phase flash.

9. The method of claim 1 wherein an overcurrent status is declared when a measured current on any of the three phases on the load side of the network protector exceeds the high current threshold.

10. The method of claim 9 wherein an overcurrent status is declared when a phasor sum of the measured currents on the three phases on the load side of the network protector exceeds the high current threshold.

11. The method of claim 1 wherein the method is implemented in a relay which controls the network protector and the relay is adapted to receive external commands from a remote location to use the method or to disable the method, so that a series of relays controlling a set of network protectors in proximity to one another may all be set to use the method before personnel come close to the set of network protectors and then after the personnel are no longer close to the set of network protectors, the relays may be instructed to stop using the method.

12. A relay for controlling a network protector, the relay configured to:
monitor current flow on all three phases on a load side of the network protector and a ground current until a monitored current exceeds a high current threshold,
then
declare an overcurrent status,
check a set of secondary parameters to see if an aberrant value is detected to confirm that the overcurrent status appears to indicate an arc flash; and
trip the network protector to stop a flow of current to the arc flash.

13. The relay of claim 12 wherein a delay parameter is set so that the relay does not immediately act to trip the network protector to stop the flow of current to the arc flash but looks for several consecutive measurement sets that indicate both an overcurrent and at least one secondary parameter with an aberrant value.

14. The relay of claim 12 wherein a delay parameter is set so that the relay does not immediately act to trip the network protector to stop the flow of current to the arc flash but looks for several consecutive measurement sets that indicate both an over current and one particular secondary parameter that maintains an aberrant value.

15. The relay of claim 12 having a communication port for receiving instructions from a remote location and having an ability to reversibly switch into a safe service mode where the relay:
monitors current flow on all three phases on a load side of the network protector and a ground current until a monitored current exceeds a high current threshold,
then
declares an overcurrent status,
checks a set of secondary parameters to see if an aberrant value is detected to confirm that the overcurrent status appears to indicate an arc flash; and
trips the network protector to stop a flow of current to the arc flash
wherein while in safe service mode, the relay acts quickly to trip the network protector to provide additional protection for personnel doing work in proximity to the relay.
